(19) United States
(12) Patent Application Publication
(10) Pub. No.: US 2020/0200107 A1
(43) Pub. Date: Jun. 25, 2020

(54) TWIN-SCROLL TURBINE WITH FLOW CONTROL VALVE

(71) Applicant: GM GLOBAL TECHNOLOGY OPERATIONS LLC, Detroit, MI (US)

(72) Inventors: Alberto Racca, Cavallermaggiore (IT); Tom Verstraete, Halle (BE); Johan Prinsier, Lokeren (BE)

(21) Appl. No.: 16/226,958

(22) Filed: Dec. 20, 2018

(51) Int. Cl. F02D 41/00; F02B 37/00; F02B 37/007; F02B 37/18; F02B 33/36

(52) U.S. Cl. CPC F02D 41/0007; F02B 37/002; F02B 33/36; F02B 37/183; F02B 37/007

(57) ABSTRACT

An internal combustion engine includes a twin-scroll turbocharger with a flow control valve along the larger of the two scrolls. At low engine speeds, the valve is closed so that all exhaust gases are routed through the smaller scroll. At higher engine speeds, the valve opens to reduce back pressure and provide the desired boost in the power band of the engine. The overall swallowing capacity of the turbine is disproportionally divided between the scrolls, such as a 75/25 split between the large and small scrolls.

### INTRODUCTION

The field of technology generally relates to turbochargers used with internal combustion engines.

Turbochargers can be used with internal combustion engines to improve engine performance and/or efficiency by recovering some of the otherwise wasted energy downstream of the combustion chambers. A turbine is positioned in the flow of engine exhaust gas and is coupled with a compressor positioned at the air intake side of the engine. The flowing exhaust gases turn the turbine and, in turn, the compressor, which increases air intake pressure and the fuel-burning capacity of the engine. A long-time problem with turbochargers is poor performance at low engine speeds at which the turbine, and therefore the compressor, do not turn fast enough to appreciably increase air intake pressure. Solutions have been proposed, such as variable geometry turbines (VGTs) or two-stage turbocharger systems. But such configurations are complex and expensive and find limited application with gasoline engines, which exhibit higher operating temperatures than their diesel counterparts.

### SUMMARY

According to one embodiment, an internal combustion engine includes a bank of one or more combustion chambers, a turbocharger, and a flow control valve. The bank of combustion chambers has an intake side and an exhaust side. The turbocharger includes a turbine at the exhaust side coupled with a compressor at the intake side. The turbocharger has separate first and second scrolls that route exhaust gases from the one or more combustion chambers through the turbine. The flow control valve is located along the first scroll and is operable to change an amount of exhaust gas that flows through the turbine via the first scroll.

In various embodiments, the first scroll is larger than the second scroll.

In various embodiments, the turbine has a swallowing capacity, and at least 65% of the swallowing capacity is provided by the first scroll.

In various embodiments, the flow control valve is located at an inlet end of the first scroll.

In various embodiments, the flow control valve is configured to be in a closed position at a first range of engine speeds and in an open position at a second range of engine speeds that are greater than the engine speeds of the first range. Exhaust gases thereby flow through the turbine via only the second scroll at the first range of engine speeds and via both scrolls at the second range of engine speeds.

In various embodiments, the flow control valve is configured to be in a partially open position at an engine speed between the first and second ranges of engine speeds.

In various embodiments, the bank of one or more combustion chambers includes a plurality of combustion chambers with exhaust gases from all of the combustion chambers routed to a common conduit in fluid connection with both scrolls of the turbocharger.

In various embodiments, exhaust gases from the first and second scrolls are combined at an outlet end of the scrolls before impinging an impeller of the turbine.

In various embodiments, the turbine does not include a wastegate.

Another embodiment of the internal combustion engine includes a twin-scroll turbocharger. Exhaust gases from each of a plurality of combustion chambers are routed through the turbocharger via both scrolls of the turbocharger at engine speeds within a power band of the engine.

In various embodiments, a ratio of exhaust gases in one scroll to exhaust gases in the other scroll is variable.

In various embodiments, the engine includes a flow control valve operable to vary said ratio.

In various embodiments, exhaust gases from each of the plurality of combustion chambers are routed through the turbocharger via only one scroll of the turbocharger at engine speeds below the power band of the engine.

In various embodiments, a ratio of exhaust gases in a larger one of the scrolls to exhaust gases in a smaller one of the scrolls is variable between 0 and 5.7.

In various embodiments, the ratio is zero at engine speeds below the power band of the engine and greater than zero within the power band.

It is contemplated that any of the features listed above, illustrated in the drawings, and/or described below can be combined with any one or more of the other features except where there is an incompatibility of features.

### BRIEF DESCRIPTION OF THE DRAWINGS

Illustrative embodiments will hereinafter be described in conjunction with the appended drawings, wherein like designations denote like elements, and wherein:

FIG. 1 is a schematic view of an internal combustion engine that includes a flow control valve along one scroll of a twin-scroll turbocharger; and

FIG. 2 is a cross-sectional view of an exemplary twin-scroll turbine housing with differently sized scrolls.

### DETAILED DESCRIPTION

As described below, a twin-scroll turbocharger can be configured in an unconventional manner to obtain performance competitive with VGT turbochargers without the complexity, expense, or high-temperature sensitivity normally associated with VGTs. In various embodiments, the overall swallowing capacity of the turbine is disproportionally divided between scrolls, and a flow control valve regulates flow through the larger of the scrolls to provide increased performance at low engine speeds without sacrificing performance at high engine speeds.

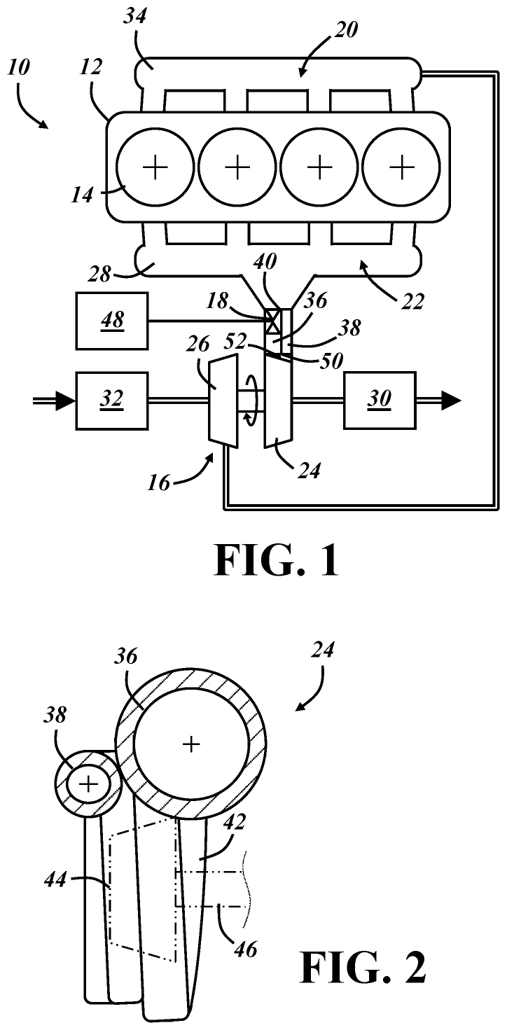

FIG. 1 is a schematic view of an illustrative internal combustion engine 10, including a bank 12 of one or more combustion chambers 14, a turbocharger 16, and a flow control valve 18. The bank 12 of combustion chambers 14 has an intake side 20 and an exhaust side 22. The turbocharger 16 includes a turbine 24 at the exhaust side 22 coupled with a compressor 26 at the intake side 20. Exhaust gases are routed from the combustion chambers 14 to the turbine 24 along an exhaust manifold 28. The exhaust gas turns a rotor in the turbine 24, which operates the compressor 26, then exits the turbine to the remainder of the vehicle exhaust system 30. Air enters the engine 10 via components of an air intake system 32 and is pressurized by the compressor 26 before reaching an intake manifold 34, which distributes the pressurized air to the combustion chambers 14, where it is mixed with fuel for combustion. Engines are of course complex machines, and other engine components and systems (e.g., a fuel system, an EGR system, an ignition system, etc.) are omitted for simplicity in explanation. The illustrated example is a 4-cylinder engine, but any number of cylinders is possible. In some embodiments (e.g., V6 or V8 engines), there is more than one bank 12 of combustion chambers 14 that power the turbocharger 16, or each bank may include a dedicated and independently controllable turbocharger 16.

The illustrated turbine 24 is a twin-scroll turbine with separate first and second scrolls 36, 38 that route exhaust gases from the combustion chambers 14 through the turbine. In particular, exhaust gases reach the turbine 24 via the exhaust manifold 28 and enter the turbine at an inlet end 40 of the scrolls 36, 38. As illustrated in FIG. 2, the scrolls 36, 38 are formed in a housing 42 of the turbine 24. The turbine housing 42 surrounds an impeller 44 of a rotor 46, which is illustrated schematically in phantom view in FIG. 2. Exhaust gases exit the scrolls 36, 38 at an opposite outlet end within the housing 42 and impinge the blades of the impeller 44.

Referring again to FIG. 1, the flow control valve 18 is located along the first scroll 36 and is operable to change an amount of exhaust gas that flows through the turbine 24 via the first scroll. The valve 18 may have a fully closed position in which exhaust gases are prevented from flowing through the turbine 24 via the first scroll 36. The valve 18 may also have partially and fully open positions in which exhaust gases are permitted to flow through the turbine 24 via the first scroll. In this example, exhaust gases are always permitted to flow through the second scroll 38. With this configuration, a ratio of exhaust gases in one scroll to exhaust gases in the other scroll is variable via operation of the valve 18.

The illustrated valve 18 is located at the inlet end 40 of the scroll 36 and may be operated by an actuator 48, which controllably changes the position or state of the valve 18. Placement of the valve 18 at the inlet end 40 of the scroll reduces eddies or other unwanted fluid flow phenomena that may occur if the valve is located at the outlet end of the scroll. The actuator 48 may be integral to the valve 18 and/or under the control of an engine control module or other controller. In other embodiments, the valve 18 is passively actuated, such as by exhaust manifold pressure. The valve 18 may be a poppet valve, a throttle valve, or other type of flow-restricting valve and may have only two positions (open/closed or partly/fully open), or it may have more than two positions, at least one of which is partially open. With a plurality of partially open positions, the valve 18 can be continuously variable with respect to the flow restriction, or it may have several distinct partially open positions between the open and closed positions. A higher number of different partially open positions results in higher resolution control over the flow of exhaust gases through the first scroll 36 and over the ratio of exhaust gases in the two scrolls.

The range of available ratios is a function of the relative sizes of the scrolls 36, 38. For instance, if the scrolls 36, 38 are the same size, anywhere from 50% to 100% of the exhaust gases will always flow through the second scroll 38, while anywhere from 0% to 50% of the exhaust gases will flow through the first scroll 36. The corresponding ratios of exhaust gas in the first scroll 36 to exhaust gas in the second scroll 38 is in a range from 0 to 1. Accordingly, the effective aspect ratio (A/R) of the turbine 24 can be varied via operation of the valve 18. In the above example with identically sized scrolls, the aspect ratio of the turbine 24 can effectively be doubled when the valve 18 changes from the closed position to the open position, or effectively halved with the valve changes from open to closed. In other words, the illustrated turbine 24 can behave like a low A/R turbine when the valve 18 is closed and like a high A/R turbine when the valve is open. With a valve 18 having a plurality of partially open positions, whether stepped or continuous, the effective aspect ratio can be optimized as a function of engine speed.

In the examples in the figures, the first scroll 36 is larger than the second scroll 38, which allows for a higher range of ratios of exhaust gases flowing through each scroll 36, 38. For example, the turbine 24 may be characterized by a swallowing capacity, over half of which is provided by the scroll 36 along which the control valve 18 is provided. Swallowing capacity refers to the amount of gas a turbine scroll is capable of allowing to pass through the scroll per unit time and can be expressed in kilograms per sec (kg/s) or any equivalent. As used here, the swallowing capacity of the turbine 24 is equal to the sum of the swallowing capacities of the both scrolls 36, 38 with the valve 18 fully open.

In various embodiments, the first scroll 36 may provide up to 85% of the swallowing capacity of the turbine 24. While it is not unusual for the scrolls of conventional twin-scroll turbines to inherently have a small swallowing capacity differential, due mainly to packaging and component geometry issues, the capacity split between scrolls is typically 55% for one scroll and 45% for the other. Indeed, a differential much higher than that tends to cause flow imbalance issues in the engine due to each scroll being associated with different cylinders of the engine in a conventional twin-scroll system. In the illustrated example, exhaust gases from all of the cylinders 14 of the engine 10 are routed to and connected with both scrolls 36, 38 of the turbine 24 via a common conduit—i.e., the exhaust manifold 28.

The first scroll 36 may provide anywhere from 65% to 85% of the swallowing capacity of the turbine 24. Accordingly, the second scroll 38 may provide anywhere from 15% to 35% of the swallowing capacity of the turbine 24. The small scroll 38 defines the minimum effective swallowing capacity of the turbine, which is the apparent swallowing capacity when the control valve 18 is closed. In other embodiments, the small scroll 38 provides between 20% and 30% of the swallowing capacity of the turbine 24. It is noted that the cross-section of FIG. 2 is non-limiting and presented for ease in explanation. For example, the cross-sectional shapes of the scrolls may be non-circular and non-elliptical.

The relative scroll-to-scroll capacity differentials can also be expressed as ratios as with the 50/50 split noted above, where the ratio of the amount of exhaust gas flowing through the first scroll 36 to the amount of exhaust gas flowing through the second scroll 38 is variable within a range from 0 to 1 via operation of the control valve 18. In an example where the first scroll provides 85% of the swallowing capacity of the turbine 24, this ratio is variable in a range from 0 to about 5.7. The lowest possible ratio is always zero when the valve 18 is configured with a fully closed position. And the high end of the ratio range is the quotient of the portion of the swallowing capacity provided by the first scroll 36 and the portion of the swallowing capacity provided by the small scroll 38.

In various embodiments, the ratio of exhaust gases between the scrolls 36, 38 is zero at engine speeds outside of a power band of the engine and greater than zero within the power band. The power band is a range of engine speeds that is only a portion of the total range of engine speeds between idle engine speed and maximum rated engine speed (i.e., redline). For purposes of this description, the power band is defined as upper half of the total range of engine speeds. In a non-limiting example, an engine that idles at 1000 rpm and redlines at 8000 rpm therefore has its power band in an engine speed range between 4500 rpm and 8000 rpm. This does not mean that the flow control valve 18 is closed at all engine speeds outside the power band an open at all engine speeds within the power band. The open or closed state of the valve 18 will vary with the power and/or torque profile of the particular engine.

In some embodiments, exhaust gases exit each of the scrolls 36, 38 at an outlet end 50 into a common channel 52, where they are combined before impinging the impeller. This is illustrated only schematically in FIG. 1. The channel 52 is formed within the turbine housing. This differentiates the illustrated example from a VGT system, which typically includes a series of vanes at the outlet end of the scroll which move to change the direction and/or amount of the exhaust gas exiting the scroll to impinge the impeller. Stated differently, embodiments of the turbine do not include a VGT unit or cartridge. Another advantage of the described control valve regulation of exhaust gas flow through the turbine is the absence of VGT vanes, which are not only complex to build and operate, but also occupy precious volume within the turbine housing—even when the vanes are fully open—that could otherwise contribute to additional swallowing capacity.

In addition, the turbocharger 16 does not require a wastegate to vent or otherwise divert excess exhaust gas pressure away from the turbine. The control valve-equipped turbine 24 can instead be designed with a maximum size that will not appreciably choke the engine at its highest speeds, using the control valve 18 to at least partly restrict the larger scroll 26 at lower engine speeds when the entire scroll capacity is unnecessary and, indeed, undesirable. The absence of a wastegate means more of the available exhaust energy is used to power the turbocharger 16.

In an exemplary mode of operation, the flow control valve 18 is in the fully closed position while the engine 10 is operating within a range of low mass flow rates corresponding to a partial load and low-end torque range. In this range of low mass flow rates, the entire mass flow passes through the second scroll 38 to turn the turbine rotor and operate the compressor 26 to increase intake pressure. During a transition to higher engine speeds and higher mass flow rates (e.g., during acceleration) the closed control valve 18 will lead to an increase in backpressure on the engine, and more favorable operating conditions can be achieved via movement of the control valve to a partially open position. The effect is a reduction in back pressure on the engine along with an increase in available compression in the compressor. During transition to even higher engine speeds and mass flow rates, the flow control valve 18 is progressively opened, eventually reaching the fully open position at engine speeds corresponding to rated or peak engine power. With the valve 18 fully open, both scrolls are able to use their entire capacity to turn the turbine rotor and operate the compressor at maximum boost pressure.

As engine designers have begun to consider VGT systems to replace wastegated turbochargers in attempts to squeeze more efficiency from the engine, the above-described control valve system offers a less complex and lower cost system. This is particularly true with gasoline engines, which tend to operate at higher temperatures than diesel engines and thereby cause problems with the long-term durability and accuracy of VGT systems.

It is to be understood that the foregoing description is not a definition of the invention but is a description of one or more exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. An internal combustion engine, comprising:
a bank of one or more combustion chambers having an intake side and an exhaust side;
a turbocharger comprising a turbine at the exhaust side coupled with a compressor at the intake side, the turbocharger having separate first and second scrolls that route exhaust gases from the one or more combustion chambers through the turbine; and
a flow control valve located along the first scroll, said valve being operable to change an amount of exhaust gas that flows through the turbine via the first scroll.

2. The internal combustion engine of claim 1, wherein the first scroll is larger than the second scroll.

3. The internal combustion engine of claim 1, wherein the turbine has a swallowing capacity, at least 65% of the swallowing capacity being provided by the first scroll.

4. The internal combustion engine of claim 1, wherein the flow control valve is located at an inlet end of the first scroll.

5. The internal combustion engine of claim 1, wherein the flow control valve is configured to be in a closed position at a first range of engine speeds and in an open position at a second range of engine speeds that are greater than the engine speeds of the first range, whereby exhaust gases flow through the turbine via only the second scroll at the first engine speed and via both scrolls at the second engine speed.

6. The internal combustion engine of claim 4, wherein the flow control valve is configured to be in a partially open position at an engine speed between the first and second ranges of engine speeds.

7. The internal combustion engine of claim 1, wherein the bank of one or more combustion chambers includes a plurality of combustion chambers with exhaust gases from all of the combustion chambers routed to a common conduit in fluid connection with both scrolls of the turbocharger.

8. The internal combustion engine of claim 1, wherein exhaust gases from the first and second scrolls are combined at an outlet end of the scrolls before impinging an impeller of the turbine.

9. The internal combustion engine of claim 1, wherein the turbine does not include a wastegate.

10. An internal combustion engine comprising a twin-scroll turbocharger, wherein exhaust gases from each of a plurality of combustion chambers are routed through the turbocharger via both scrolls of the turbocharger at engine speeds within a power band of the engine.

11. The internal combustion engine of claim 10, wherein a ratio of exhaust gases in one scroll to exhaust gases in the other scroll is variable.

12. The internal combustion engine of claim 11, further comprising a flow control valve operable to vary said ratio.

13. The internal combustion engine of claim 10, wherein exhaust gases from each of the plurality of combustion chambers are routed through the turbocharger via only one scroll of the turbocharger at engine speeds below the power band of the engine.

14. The internal combustion engine of claim 10, wherein a ratio of exhaust gases in a larger one of the scrolls to exhaust gases in a smaller one of the scrolls is variable between 0 and 5.7.

15. The internal combustion engine of claim 14, wherein said ratio is zero at engine speeds below the power band of the engine and greater than zero within the power band.
